(19) United States
(12) Patent Application Publication
(10) Pub. No.: US 2024/0161131 A1
(43) Pub. Date: May 16, 2024

(54) SYSTEMS AND METHODS FOR HANDLING INCOMING CALLS

(71) Applicant: Calvin LIM, Edmonton (CA)

(72) Inventor: Calvin LIM, Edmonton (CA)

(21) Appl. No.: 18/419,902

(22) Filed: Jan. 23, 2024

Related U.S. Application Data
(63) Continuation of application No. 17/139,199, filed on Dec. 31, 2020.
(60) Provisional application No. 62/956,333, filed on Jan. 2, 2020.

(51) Int. Cl. G06Q 30/0201; G06N 20/00

(52) U.S. Cl. CPC G06Q 30/0201; G06N 20/00

(57) ABSTRACT

Systems and methods for handling incoming calls using numeric scores associated with each caller. When an incoming call is received, a numeric score associated with the caller is compared to a predetermined value. Based on the comparison, the call can be redirected to an automated/autonomous system or presented to a human for further analysis. In some embodiments, the numeric score is displayed to the human when the call is directed to them. The numeric score represents a probability that the call will generate income for the call recipient. The numeric score is generated based on analysis of past data and interactions between the caller and the call recipient. The analysis preferably uses machine learning methods and a trained machine learning model that outputs the numeric scores. Methods of generating the numeric scores using a trained machine learning model and of training the machine learning model are also disclosed.

### RELATED APPLICATIONS

This application is a Continuation-in-Part of U.S. patent application Ser. No. 17/139,199 filed on Dec. 31, 2020, which claims the benefit of priority from U.S. Provisional Patent Application No. 62/956,333, filed on Jan. 2, 2020.

### TECHNICAL FIELD

The present invention relates to handling incoming calls. More specifically, the present invention relates to efficiently handling incoming calls using machine learning-based approaches.

### BACKGROUND

Providing satisfactory customer support is an integral part of every business. It has been established time and again by many businesses that providing the best customer support is the fundamental strategy to keep up with competition. Hence, businesses are focusing more on providing high-quality customer support to keep their customers happy and content.

Conventional methods for providing customer support include providing solutions to issues faced by customers by communicating with them via voice (phone-based support) or text (e-mail and live chat). In most cases, customer support personnel are employed to directly communicate with customers and provide them a reasonable solution to the issues faced by them. While experienced personnel may handle even the toughest customers with relative ease, it may not be possible to employ such personnel for every request. Further, customers who have low potential value to the business may nevertheless take substantial time for the customer support personnel to handle, preventing them from assisting other clients who may be more valuable to the business or may have more complex problems that require human assistance. Systems and methods for automatically redirecting such low-value calls may be extremely valuable for businesses and more helpful for the customers.

As more and more business is transacted over telephone calls, it has become important for a business to manage incoming calls and prioritize them based on parameters such as the client's profitability and the client's potential risk. The use of machine learning system could assist in calculating and/or assessing such parameters for clients, including for repeat clients and new clients, and efficiently direct calls in real-time.

### SUMMARY

This document discloses systems and methods for handling incoming calls using numeric scores associated with each caller. When an incoming call is received, a numeric score associated with the caller is compared to a predetermined value. Based on the comparison, the call can be redirected to an automated system or presented to a human for further analysis. The numeric score represents a probability that the call will generate income for the call recipient. The numeric score is generated based on analysis of past data and interactions between the caller and the call recipient. The analysis preferably uses machine learning methods and a trained machine learning model that outputs the numeric scores. This document also discloses a method of generating the numeric scores using a trained machine learning model and a method of training the machine learning model.

In a first aspect, this document discloses a method for handling incoming calls, the method comprising: (a) receiving, at a server, an incoming call from a telephone system, said incoming call being made by a caller; (b) using said server, querying a caller database to retrieve a numeric score for said caller; (c) at said server, comparing said numeric score to a predetermined value; and (d) using said server, directing said telephone system to take an action based on said comparison in step (c), wherein said action comprises one of: automatically redirecting said incoming call to a voicemail inbox for a recipient of said incoming call; automatically redirecting said incoming call to an autonomous chatbot; automatically redirecting said incoming call to an automated telephone information system; and automatically redirecting said incoming call to a device used by said recipient of said call.

In another embodiment, this document discloses a method further comprising displaying said numeric score to said recipient of said incoming call when said incoming call is redirected to said device.

In another embodiment, this document discloses a method wherein a caller portrait is not found in said caller database and wherein step (b) comprises: (b1) creating a new caller portrait for said caller in said caller database, said new caller portrait thereby being said caller portrait; and (b2) assigning a default score to said caller portrait, said default score thereby being said numeric score.

In another embodiment, this document discloses a method wherein said numeric score represents a probability that said incoming call will generate income for said recipient of said incoming call.

In another embodiment, this document discloses a method further comprising (e) recording new information related to said incoming call in said caller portrait.

In another embodiment, this document discloses a method further comprising the step of: (f) generating a revised numeric score based on said caller portrait including said new information.

In another embodiment, this document discloses a method wherein said numeric score is generated based on analysis of pre-existing data related to said caller, said data being stored in said caller portrait and said analysis comprising machine learning.

In another embodiment, this document discloses a method wherein said analysis comprises: receiving a corpus of data related to said caller, said corpus comprising said caller portrait; extracting a set of characteristic values for said caller from said data; and providing said set of characteristic values as a vector input to a trained machine learning model, wherein said trained machine learning model outputs said numeric score.

In another embodiment, this document discloses a method wherein said extracting uses natural language processing.

In another embodiment, this document discloses a method wherein preprocessing is performed on said data before said set of characteristic values is extracted.

In another embodiment, this document discloses a method wherein said corpus of data comprises any of: biographical information of said caller; personal identifiable information of said caller; demographic information of said caller; financial information relating to said caller; insurance indemnity information relating to said caller; data related to personal property of said caller; internal notes related to said caller; invoices for past transactions with said caller; transcripts of past conversations with said caller; audio recordings of past conversations with said caller; video recordings of past conversations with said caller; and third-party information related to said caller.

In another embodiment, this document discloses a method further comprising analyzing said incoming call said server in near real time to refine the numeric score before step (c).

In another aspect, this document discloses a method for training a machine learning model to determine a numeric score for an incoming call, wherein said numeric score represents a probability that said incoming call will generate income for a recipient of said incoming call, wherein said incoming call is made by a caller, and wherein a plurality of characteristics of said caller are associated with said probability, said method comprising: (a) for each of said characteristics, randomly generating a plurality of model values; (b) generating feature vectors using said model values, each of said feature vectors comprising a model value for each of said characteristics and each of said feature vector having a predicted numeric score associated therewith; (c) providing at least a subset of said feature vectors to said machine learning model; and (d) using reinforcement learning, repeating step (c) until differences between outputs of said machine learning model and predicted numeric scores for said feature vectors are within a predetermined range.

In another embodiment, this document discloses a method wherein step (b) is based on a plurality of value rules that reflect correlations between said characteristics and said probability.

In another aspect, this document discloses a system for handling incoming calls, said system comprising: a server configured to receive an incoming call from a telephone system, said call being made by a caller and said server being in communication with a source of data regarding said caller; processing circuitry in communication with said server; and at least one memory unit storing computer-readable and computer-executable instructions, such that, when said instructions are executed by said processing circuitry, said system implements a method comprising: (a) retrieving a numeric score associated with said caller from said source of data; (b) at said server, comparing said numeric score to a predetermined value; and (c) using said server, directing said telephone system to take an action based on said comparison in step (b), wherein said action comprises one of: automatically redirecting said incoming call to a voicemail inbox for a recipient of said incoming call; automatically redirecting said incoming call to an autonomous chatbot; automatically redirecting said incoming call to an automated telephone information system; and automatically redirecting said incoming call to a device used by said recipient of said call.

In another embodiment, this document discloses a system wherein said numeric score represents a probability that said incoming call will generate income for said recipient of said incoming call.

In another embodiment, this document discloses a system further comprising an analysis module implemented by said processing circuitry, said analysis module analyzing said caller portrait using machine learning to generate said numeric score.

In another embodiment, this document discloses a system wherein said analysis comprises: receiving a corpus of data related to said caller, said corpus comprising said caller portrait; extracting a set of characteristic values for said caller from said data; and providing said set of characteristic values as a vector input to a trained machine learning model, wherein said trained machine learning model outputs said numeric score.

In another embodiment, this document discloses a system wherein said extracting uses natural language processing.

In another embodiment, this document discloses a system wherein said corpus of data comprises any of: biographical information of said caller; personal identifiable information of said caller; demographic information of said caller; financial information relating to said caller; insurance indemnity information relating to said caller; data related to personal property of said caller; internal notes related to said caller; invoices for past transactions with said caller; transcripts of past conversations with said caller; audio recordings of past conversations with said caller; video recordings of past conversations with said caller; and third-party information related to said caller.

### BRIEF DESCRIPTION OF THE DRAWINGS

The present invention will now be described by reference to the following figures, in which identical reference numerals refer to identical elements and in which:

FIG. 1A is a flowchart detailing a method of call handling according to an aspect of the invention;

FIG. 1B is a flowchart detailing a method of call handling according to another embodiment of the invention;

FIG. 2A is a block diagram of a system for call handling according to another aspect of the invention;

FIG. 2B is a block diagram of another embodiment of the system of FIG. 2A;

FIG. 3 is a flowchart detailing a method of generating a numeric score for use in call handling; and

FIG. 4 is a flowchart detailing a method of training a machine learning model according to an aspect of the invention.

### DETAILED DESCRIPTION

The present invention provides systems and methods for efficient handling of incoming calls using machine learning. When an incoming call is received, a numeric score associated with the caller is compared to a predetermined value. Based on the comparison, the call can be redirected to an automated system, a partially or fully autonomous system such as a chatbot, or to a human for further analysis. In some embodiments, the numeric score is displayed to the human when the call is directed to them. The numeric score is correlated with a probable monetary value of the call to the call recipient and is generated based on analysis of past data and interactions between the caller and the call recipient. The analysis uses machine learning methods and a trained machine learning model that outputs the numeric scores.

To better understand the present invention, the reader is directed to the listing of citations at the end of this description. For ease of reference, these citations and references have been referred to by their listing number throughout this document. The contents of the citations in the list at the end of this description are hereby incorporated by reference herein in their entirety.

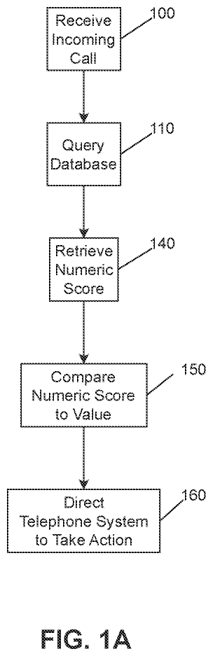

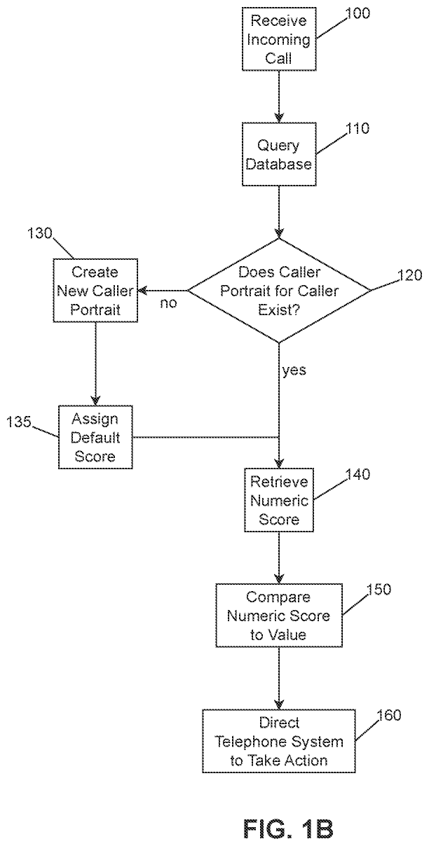

FIG. 1A is a flowchart detailing a method for handling incoming calls according to an aspect of the present invention. At step 100, an incoming call is received from a caller at a telephone system. At step 110, a server in communication with the telephone system queries an associated caller database. A numeric score associated with a caller portrait of the caller is retrieved from the caller database at step 140.

At step 150, the numeric score is compared to a predetermined value. As described below, the specific value depends on the organization receiving the call and may include a series of values (i.e., a range or group of ranges). Based on the results of the comparison at step 150, the server directs the telephone system to take an action at step 160. For example, if step 150 determined that the caller's numeric score is higher than the predetermined value (in this example, indicating a ‘high-value client’, i.e., that the call has a high probability of generating income for the recipient), the action may be presented to the recipient using the telephone system.

The numeric score may also be displayed to the recipient when the call is presented to them, so that they are aware of the potential value of the call and/or can choose whether to accept or decline. The display may be presented on an interface of a desktop telephone, of a mobile phone or other mobile communication device, and/or on any display screen that is responsive to directions from the server, such as a screen of a computer in use by the recipient of the call. Additionally, other information from the database and/or server may be displayed on the interface and/or display screen, such as the caller name or any other suitable or desired information.

Of course, other actions may be performed by the system, depending on the embodiment and the specific needs and desires of the call recipient. As one non-limiting example, in some embodiments, the call may be flagged as ‘spam’ (e.g., when a caller ID associated with the caller is found in a database of known spam callers). In such cases, the spam call may be automatically rejected and/or blocked.

In contrast, if step 150 determined that the caller's numeric score is lower than the predetermined value, the call may be automatically redirected to a voicemail inbox for the recipient, so that the caller can leave a voicemail message. As another option, the call may be automatically redirected to an automated telephone information system (also known as a “phone tree”) that provides a series of prerecorded messages to the caller and typically accepts their input in the form of keypresses and/or simple audio responses (e.g., “Yes”, “No”, spoken numbers, letters, and/or names). Such automated telephone information systems can be very useful for simple tasks (such as providing standardized forms or making simple changes to client information) that do not require skilled human intervention. As still another option, the call may be automatically redirected to a fully or partially autonomous chatbot system that can interact in a responsive manner with the caller.

FIG. 1B is a flowchart detailing a method similar to that in FIG. 1A, except that in FIG. 1B, the caller database is queried at step 110 to determine whether a caller portrait for the caller already exists in the caller database, at decision 120. If, at decision 120, it is determined that a caller portrait already exists, a numeric score associated with that caller portrait is retrieved from the caller database at step 140. The numeric score represents a probability that the incoming call will generate income for the recipient of the call, based on past experiences/interactions with the caller and/or similar callers.

However, if, at step 120, it is determined that a caller portrait does not already exist for the caller (for instance, in the case of a first-time caller/client), a new caller portrait is created at step 130 for the caller. The new caller portrait is then stored in the caller database. The new caller portrait is assigned a default numeric score at step 135. This default numeric score is retrieved at step 140 and is considered to be the numeric score of the caller portrait. Steps 150 and 160 proceed as described in reference to FIG. 1A above.

As should be clear, the “caller” is the individual making the call. The individual may be making the call on their own behalf or on behalf of an organization and/or business with which they are associated. The caller portrait preferably accounts for such distinctions: i.e., both “organization” portraits and “individual” portraits are preferably maintained by the database. An “organization” portrait would typically include little to no biographical detail on the individual caller(s) who make calls on behalf of the organization. For example, an organization portrait might contain the names of frequent callers for the organization, but would not need to retain or include ages of the caller(s). However, the age of the organization itself, or its date of incorporation (if applicable) could be relevant to the assessment of the value of the call, and therefore might be usefully retained as part of the caller portrait for that organization.

The “receiver” or “recipient” of the call is the individual receiving the call, or the business or organization receiving the call. Typically, when callers call a business/organization without trying to reach a specific individual, their calls are answered by a receptionist, secretary, or any individual authorized to answer calls. The present invention may therefore free up time for these individuals by providing efficient call handling.

The term “caller portrait” as used herein refers to all available information about the caller/client. Depending on the embodiment, the caller portrait may include basic information including biographical information and/or personal identifiable information of the caller (e.g., age, name, address, gender or sex, occupation or profession, etc.) and/or higher-level demographic information (e.g., age range, nationality, ethnicity). The caller portrait may also include financial information relating to the caller (e.g., income, net worth, liabilities, insurance information, including insurance indemnity information relating to the caller, etc.), and data related to personal property of said caller (e.g., real estate, vehicles, etc.). The caller portrait may also include internal files and documents related to said caller from previous interactions with the caller, including without limitation: internal notes related to the caller; invoices for past transactions with the caller; transcripts of past conversations with the caller; audio recordings of past conversations with the caller; and/or video recordings of past conversations with the caller.

Additionally, information related to the caller can be obtained from third-party sources and added to the caller portrait (referred to herein as “third-party information”). Such third-party information may include information gathered from social media or news sites, public records, and any other available types of information that may be relevant to the assessment of the value of the call.

Further, each call preferably provides new information regarding the caller. This new information is, in some embodiments, added to the caller portrait. The numeric score can then be reassessed based on the whole caller portrait, including the new information, to determine a revised numeric score. The revised numeric score can then be stored on the caller portrait as the numeric score. (In some embodiments, old or outdated numeric scores may also be retained in a score history portion of the caller portrait, which may itself provide useful information for determining a current numeric score at any time.) This new information may be gathered regardless of the outcome of the incoming call. For example, if a caller is redirected to an automated telephone information system and hangs up without providing any input to the system, the act of hanging up could be recorded in the caller portrait. Recording such actions could allow the system to recognize a caller who is repeatedly redirected and is not finding what they need in the automated information system. To preserve a relationship with that caller, a human response may be needed on their next call. Thus, in some embodiments, the numeric score could account for such information.

As well, in some embodiments, the numeric score may be at least partially based on details of the incoming call itself. In one approach, incoming audio and/or video may be extracted and analyzed in real time/near real time to identify a topic of the call. For example, topic analysis using natural language processing methods on the incoming audio may reroute a high-value client to an automated telephone information system when that high-value client has a simple question or is merely requesting a form (or such other similar cases). As well, sentiment analysis of the incoming call may be used to update the numeric score in real time/near real time before comparing the numeric score to the predetermined value to determine a suitable action. Preserving a relationship with an angry caller, for example, might require a human interaction even where the numeric score would otherwise indicate that the caller should be redirected to an automated system.

Numeric scores for callers may be reassessed continuously or at predetermined intervals (such as, for example, once a quarter or once a year, or any other relevant period). Some data, such as details of previous interactions, may not change, but other data (including details of more recent interactions) may be added. Additionally, details such as age or other time-based data may significantly affect the numeric score (for example, where the topic of the call relates to human health insurance), and thus are preferably reassessed on a regular basis.

As well, it should be understood that, in some embodiments, the entire caller portrait is reassessed to generate a revised score. In other embodiments, only newly added information and/or time-dependent information (e.g., age) is assessed when generating a revised score.

The incoming calls are typically received using a Voice Over Internet Protocol (VOIP) system that is in communication with a server used to implement the present invention. However, other forms of telephone, voice transmission, or audio transmission systems may be used, depending on the embodiment. It should be understood that any reference to “telephone call” or “incoming call” herein includes any audio transmission method suitably configured for handling according to the present disclosure and is not limited to conventional landline transmission, cellular transmission, or VOIP transmission. Additionally, in some embodiments, the incoming calls may be video calls or audio-only calls made over audio-visual transmission systems. All such calls should be understood to be suitable for handling according to the disclosures herein.

Similarly, all references herein to “telephone system” or “telephone network” should be understood as encompassing all suitable forms of communication network that may be used with the present invention.

The caller database may be a purpose-built caller portrait database, in some embodiments. In other embodiments, however, the caller database may be a pre-existing database that is already in use by the business, such as a Customer Relationship Management (CRM) database. Many such CRM databases are well-known and widely used. As such, in some embodiments, the present invention is configured as an extension to a third-party or pre-existing CRM database, such that integrating the present functionality into existing workflow processes is comparatively straightforward.

Querying the database, in a preferable embodiment, is performed using the telephone number of the incoming call as the lookup key for the database. In such embodiments, when a repeat client/caller places a call from a known number, that number would be used to retrieve the corresponding caller portrait. Should the same client/caller place a call from an unknown number, the system would not be able to identify them as being the same individual corresponding to the same caller portrait, and would create a new caller portrait for the individual. As multiple caller portraits for a single client/caller would lead to inefficiencies and potentially affect the assessed numeric score of the client/caller, the caller database preferably permits caller portraits to be linked to one another or merged, such that a single comprehensive portrait can be maintained for each individual placing calls.

Where a new caller portrait is created (i.e., when an existing caller portrait is not found in the database), the new caller portrait would take the number of the incoming call as the key. Other fields would be populated with null, default, or temporary values. For example, a ‘Name’ field of a new caller portrait could read ‘New Client Name’. In particular, the new caller portrait would be assigned a default numeric score. As the new caller portrait would contain little useful information related to the caller, the default numeric score is a predetermined value determined by the call recipient. For example, if the numeric score is a number between 0 and 100 with 100 indicating the highest-value clients, new callers and new caller portraits may be automatically assigned a default score of 85. In another implementation with the same 0-100 scoring system, new caller portraits may be automatically assigned a default score of 40. The default score would be chosen based on how the call recipient wishes to deal with unknown callers (e.g., by presenting them directly to human representatives or by first redirecting them to automated voicemails or information systems).

In one embodiment, the numeric score may be a percentage value (i.e., a value out of 100). The recipient of the call may designate a series of “caller tiers” or classes, with each tier or class representing a different value of client. For example, in such an embodiment, numeric scores under 50 may indicate the lowest-value clients, with higher-value clients organized into a series of 5 increasing tiers, with one tier including numeric scores between 50 and 59; a next tier including numeric scores between 60 and 69; a next tier including numeric scores between 70 and 79; a next tier including numeric scores between 80 and 89; and a final tier including numeric scores between 90 and 100. Of course, such arrangements of tiers are entirely dependent on the embodiment and implementation of the invention, as well as the needs and desires of the recipients of the call(s). As another example, a numeric score may be symmetrical about 0, such that negative numeric scores indicate lower-value clients and positive numeric scores indicate lower-value clients. It should be easily understood that an organization may design a system using as many, or as few, tiers/classes as desired, and using any desired scoring system.

It should be noted that the above paragraphs describe scoring systems where ‘high-value clients/callers’ have numerically higher scores. However, there is no requirement that the scoring system be designed in such a way. In other embodiments, lower scores may indicate higher-value clients/callers. As long as the scoring system is internally consistent and provides a mechanism for ranking the callers in relation to predetermined criteria and/or each other, the specific scoring system may be configured to suit the recipients' needs.

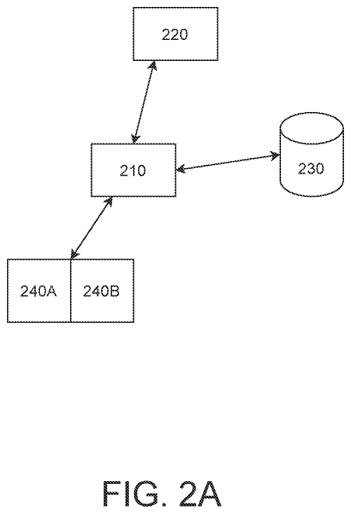

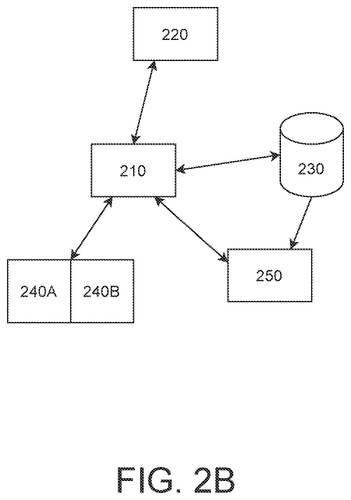

FIG. 2A is a block diagram of a system 200 that can be used to handle incoming calls as described herein. The server 210 is in communication with a telephone network 220 and a caller database 230. The system 200 further includes processing circuitry 240A and at least one memory unit 240B in communication with the server 210. The processing circuitry 240A executes instructions stored in the at least one memory unit 240B.

As should be understood, the server 210 may be a single physical server unit or may comprise a plurality of server units. Additionally, the server 210 may comprise remote, distributed, or cloud-based server unit(s), in addition to on-premise server unit(s), depending on the implementation. Additionally, the processing circuitry 240 and memory unit(s) 250 may be part of the server 210 or may be physically or logically separated from the server 210 though responsive to commands from the server 210.

In some embodiments, shown in FIG. 2B, the machine learning model(s) used in the invention may further involve dedicated processing and/or server units 250 in communication with the server 210. As is well-known, machine learning and artificial intelligence methods can be resource-intensive. Thus, depending on the embodiment, additional dedicated resources may be used to analyze the caller portraits and generate numeric scores. Again, the dedicated units 250 may be remote, distributed, and/or on-premise units, depending on the implementation.

### Calculating the Numeric Score

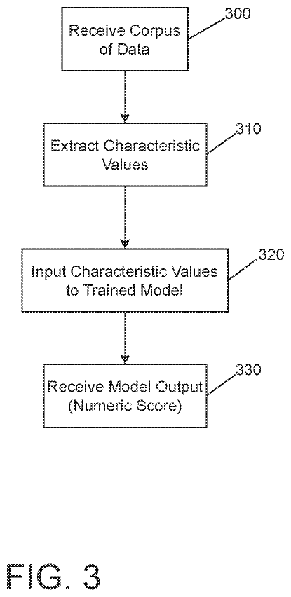

Calculating the numeric score for a given caller portrait, in some embodiments, uses machine learning. FIG. 3 is another flowchart detailing a submethod for generating the numeric score using a trained machine learning model. At step 300, a corpus of data is received from the caller database. As should be understood, the corpus of data comprises all of the data stored in the caller portrait, as described above, and may include any type of data. At step 310, a set of characteristic values for the caller is extracted from the corpus of data. Each of the characteristic values corresponds to a specific characteristic that is considered to be relevant to the value of the call. For example, in the insurance context, relevant characteristics may include the caller's age, income, overall health (or more granular health information), gender/sex, location, and number and monetary value amount of previous claims. As should be understood, the relevant characteristics will depend on the specific desired implementation of the system and methods.

At step 320, the relevant characteristics are then provided to a trained machine learning model as a vector input (i.e., a feature vector representing the relevant characteristics of the specific caller). Each element/position of the vector corresponds to a specific one of the relevant characteristics. The ordering of the elements of feature vectors within a single implementation of the system should be consistent. That is, if the first element of a first vector representing a first caller corresponds to the first caller's age, the first element of a second vector representing a second caller should correspond to the second caller's age. As well, the arrangement of the feature vectors should be the same as the arrangement of the training data/training vectors (described more below). However, provided there is internal consistency and consistency with the training data, the relevant characteristics within the feature vectors may be ordered/arranged in any suitable manner.

The trained machine learning model outputs the numeric score at step 330 based on analysis of the feature vector. The numeric score can then be used as described above.

The extracting of characteristic values to be added to the feature vector may use additional machine learning methods, including, as one non-limiting example, natural language processing (NLP) methods. Other machine learning document analysis methods can be used to extract desired characteristic value information, depending on the nature of the available data. As well, some data may be directly extracted without special processing. For example, if the age of the caller is a relevant characteristic and the age of the caller is stored in a numeric field in the caller portrait, that number may simply be copied into the corresponding position of the feature vector. In contrast, if age is a relevant characteristic but the age is not stored in a numeric field, the caller's age may need to be calculated based on a stored birthdate, which itself may need to be retrieved via document analysis (for example, using image analysis and NLP methods to retrieved the birthdate from a scanned image of the caller's driver's license or another identification document).

If a certain characteristic value is not known/not available for a given caller, a default value may be used in the feature vector. The default value, in some embodiments, is a predetermined neutral value that should have little impact on the numeric score. The default value, in other embodiments, is a null value, or a ‘DEFAULT’ or ‘UNKNOWN’ token value that the machine learning model has been trained to ignore.

Additionally, preprocessing may be performed or required on some of the documents/data in the corpus of documents before the characteristic value(s) are extracted. For example, image files that contain text data may undergo optical character recognition (OCR) processes to enable the more efficient and/or more accurate extraction of information. Many such preprocessing methods and processes are known in the art, and may be useful or necessary for different data types. As such, the present invention is not limited to any specific preprocessing techniques, nor to the presence or absence of preprocessing steps.

### Training The Machine Learning Model

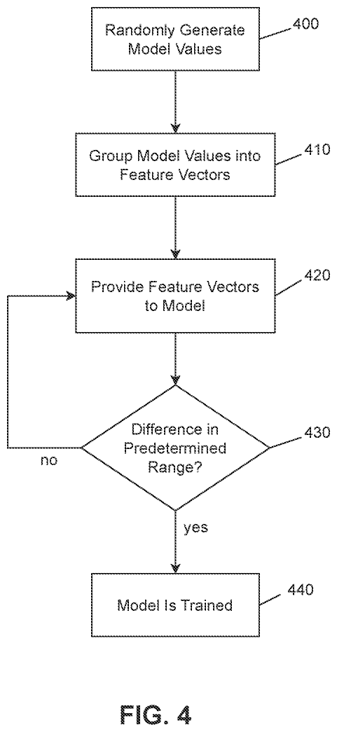

FIG. 4 is a flowchart detailing a method of training a machine learning model to output numeric scores as described above. Callers are understood to have a number of characteristics that correlate with the value of their call and/or with its probability of generating income. These characteristics can be identified by domain experts based on experience, known standards in the field, and/or based on analysis of historical data. Again, these characteristics may include any characteristics relevant to the specific implementation of the system and model. A plurality of value rules reflect correlations between the characteristics and the probability that the call will generate income. As one example, it may be known in the field that calls from callers with a net worth above a specific amount have a high probability of generating income for the call recipient. A value rule could describe such a correlation.

At step 400, a plurality of model values is randomly generated for each characteristic. At step 410, the random parameter values are grouped into feature vectors, thereby creating a plurality of vectors with each vector representing a different ‘model caller’. The feature vectors are created by applying predetermined value rules to the parameter values. The value rules are preferably designed by domain experts, such that each model caller would have a predictable value to the call recipient. That is, each model feature vector has a predicted numeric score.

As should be understood, a single randomly generated parameter value may be used in multiple model-caller feature vectors. For example, a randomly generated age of 68 could be used as the age of many model callers. Each ‘68-year-old model caller’, in this example, however, could have a different overall feature vector and a different numeric score, depending on the other values in their corresponding feature vector.

At least a subset of the feature vectors are fed to an untrained machine learning model at step 420, using well-known reinforcement learning techniques. In some embodiments, a subset of the feature vectors are provided. In some embodiments, all of the feature vectors are simultaneously provided. In reinforcement learning, the numeric scores output by the machine learning model are compared with the predicted numeric score of each feature vector and the model input is iterated until differences between the output numeric scores and the predicted numeric scores are within a predetermined (i.e., acceptable) range at decision 430. In some embodiments, including embodiments in which all of the feature vectors are simultaneously provided, new model values and feature vectors are generated at each iteration. Once differences within that range are repeatedly achieved, the model is considered to be trained (step 440).

### Interpretation

As noted above, for a better understanding of the present invention, the following references may be consulted. Each of these references is hereby incorporated by reference in its entirety:
[1] Chen, Tinggui, Xiaohua Yin, Lijuan Peng, Jingtao Rong, Jianjun Yang, and Guodong Cong. 2021. “Monitoring and Recognizing Enterprise Public Opinion from High-Risk Users Based on User Portrait and Random Forest Algorithm” Axioms 10, no. 2: 106. https://doi.org/10.3390/axioms10020106.

[2] Liu, Min, Zhiying Tu, Xiaofei Xu, and Zhongjie Wang. “Dialogue-based Continuous Update of User Portraits.” In 2021 IEEE International Conference on Services Computing (SCC), pp. 193-202. IEEE, 2021.

[3] Ly, Antoine, Benno Uthayasooriyar, and Tingting Wang. “A survey on natural language processing (nlp) and applications in insurance.” arXiv preprint arXiv:2010.00462 (2020).

[4] Chen, Yanbo, Jingsha He, Wei Wei, Nafei Zhu, and Cong Yu. “A multi-model approach for user portrait” Future Internet 13, no. 6 (2021): 147.

As used herein, the singular forms “a”, “an”, and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items. As used herein, the expression “at least one of [x] and [y]” means and should be construed as meaning “[x], [y], or both [x] and [y]”.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should be clear that the various aspects of the present invention may be implemented as software modules in an overall software system. As such, the present invention may thus take the form of computer executable instructions that, when executed, implements various software modules with predefined functions.

Embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for handling incoming calls, the method comprising:
(a) receiving, at a server, an incoming call from a telephone system, said incoming call being made by a caller;
(b) using said server, querying a caller database to retrieve a numeric score for said caller;
(c) at said server, comparing said numeric score to a predetermined value; and
(d) using said server, directing said telephone system to take an action based on said comparison in step (c), wherein said action comprises one of:
automatically redirecting said incoming call to a voicemail inbox for a recipient of said incoming call;
automatically redirecting said incoming call to an autonomous chatbot;
automatically redirecting said incoming call to an automated telephone information system; and
automatically redirecting said incoming call to a device used by said recipient of said call.

2. The method according to claim 1, further comprising displaying said numeric score to said recipient of said incoming call when said incoming call is redirected to said device.

3. The method according to claim 1, wherein, when a caller portrait is not found in said caller database, step (b) comprises:
(b1) creating a new caller portrait for said caller in said caller database, said new caller portrait thereby being said caller portrait; and
(b2) assigning a default score to said caller portrait, said default score thereby being said numeric score.

4. The method according to claim 1, wherein said numeric score represents a probability that said incoming call will generate income for said recipient of said incoming call.

5. The method according to claim 1, further comprising:
(e) recording new information related to said incoming call in said caller portrait.

6. The method according to claim 2, further comprising the step of:
(e) generating a revised numeric score based on said caller portrait including said new information.

7. The method according to claim 1, wherein said numeric score is generated based on analysis of pre-existing data related to said caller, said data being stored in said caller portrait and said analysis comprising machine learning.

8. The method according to claim 7, wherein said analysis comprises:
receiving a corpus of data related to said caller, said corpus comprising said caller portrait;
extracting a set of characteristic values for said caller from said data; and
providing said set of characteristic values as a vector input to a trained machine learning model, wherein said trained machine learning model outputs said numeric score.

9. The method according to claim 8, wherein said extracting uses natural language processing.

10. The method according to claim 8, wherein preprocessing is performed on said data before said set of characteristic values is extracted.

11. The method according to claim 5, wherein said corpus of data comprises any of:
biographical information of said caller;
personal identifiable information of said caller;
demographic information of said caller;
financial information relating to said caller;
insurance indemnity information relating to said caller;
data related to personal property of said caller;
internal notes related to said caller;
invoices for past transactions with said caller;
transcripts of past conversations with said caller;
audio recordings of past conversations with said caller;
video recordings of past conversations with said caller; and
third-party information related to said caller.

12. The method according to claim 1, further comprising analyzing said incoming call said server in near real time to refine the numeric score before step (c).

13. A method for training a machine learning model to determine a numeric score for an incoming call, wherein said numeric score represents a probability that said incoming call will generate income for a recipient of said incoming call, wherein said incoming call is made by a caller, and wherein a plurality of characteristics of said caller are associated with said probability, said method comprising:
(a) for each of said characteristics, randomly generating a plurality of model values;
(b) generating feature vectors using said model values, each of said feature vectors comprising a model value for each of said characteristics and each of said feature vector having a predicted numeric score associated therewith;
(c) providing at least a subset of said feature vectors to said machine learning model; and
(d) using reinforcement learning, repeating step (c) until differences between outputs of said machine learning model and predicted numeric scores for said feature vectors are within a predetermined range.

14. The method according to claim 13, wherein step (b) is based on a plurality of value rules that reflect correlations between said characteristics and said probability.

15. A system for handling incoming calls, said system comprising:
a server configured to receive an incoming call from a telephone system, said call being made by a caller and said server being in communication with a source of data regarding said caller;
processing circuitry in communication with said server; and
at least one memory unit storing computer-readable and computer-executable instructions, such that, when said instructions are executed by said processing circuitry, said system implements a method comprising:
(a) retrieving a numeric score associated with said caller from said source of data;
(b) at said server, comparing said numeric score to a predetermined value; and
(c) using said server, directing said telephone system to take an action based on said comparison in step (b), wherein said action comprises one of:
automatically redirecting said incoming call to a voicemail inbox for a recipient of said incoming call;
automatically redirecting said incoming call to an autonomous chatbot;
automatically redirecting said incoming call to an automated telephone information system; and
automatically redirecting said incoming call to a device used by said recipient of said call.

16. The system according to claim 15, wherein said numeric score represents a probability that said incoming call will generate income for said recipient of said incoming call.

17. The system according to claim 15, further comprising an analysis module implemented by said processing circuitry, said analysis module analyzing said caller portrait using machine learning to generate said numeric score.

18. The system according to claim 17, wherein said analysis comprises:
receiving a corpus of data related to said caller, said corpus comprising said caller portrait;
extracting a set of characteristic values for said caller from said data; and
providing said set of characteristic values as a vector input to a trained machine learning model,
wherein said trained machine learning model outputs said numeric score.

19. The system according to claim 18, wherein said extracting uses natural language processing.

20. The system according to claim 18, wherein said corpus of data comprises any of:
biographical information of said caller;
personal identifiable information of said caller;
demographic information of said caller;
financial information relating to said caller;
insurance indemnity information relating to said caller;
data related to personal property of said caller;
internal notes related to said caller;
invoices for past transactions with said caller;
transcripts of past conversations with said caller;
audio recordings of past conversations with said caller;
video recordings of past conversations with said caller; and
third-party information related to said caller.
